(19) United States
(12) Patent Application Publication
(10) Pub. No.: US 2006/0037796 A1
(43) Pub. Date: Feb. 23, 2006

(54) Hybrid motorbike powered by muscle power and an electric motor with the current generated by a fuel cell

(76) Inventor: Hans Peter Naegeli, Affoltern (CH)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/208,200

(22) Filed: Aug. 19, 2005

Related U.S. Application Data
(60) Provisional application No. 60/603,415, filed on Aug. 20, 2004.

(51) Int. Cl. B62M 23/02

(52) U.S. Cl. 180/205; 180/220; 180/65.1

(57) ABSTRACT

A hybrid motorbike is provided which is powered by human muscle power on pedals and supplemented by an electric motor with the current generated by a fuel cell on the motorbike. The rear wheel is connected to a planetary-gear train which allows both the supply of muscle power and power from the electric motor. The planetary gear has a sun wheel driven by the electric motor, and a crown gear driven by muscle power, and a planetary-gear carrier having a power take-off to the drive wheel of the bike. The fuel cell and a battery and controls may be contained in an exchangeable module in the triangular space formed in the frame of the bike between the front wheel and seat. The bike has sensors to determine the speed and load placed on the pedals which is transmitted to a microprocessor programmed to control the electric motor according to the load on the pedals and the speed to be provided the desired assistance to pedaling.

### CROSS-REFERENCE TO RELATED APPLICATION

This application claims priority to co-pending U.S. provisional application entitled, “Hybrid Motorbike Powered by Muscle Power and an Electric Motor with the Current Generated by a Fuel Cell,” having Ser. No. 60/603,415, filed Aug. 20, 2004, which is entirely incorporated herein by reference.

### BACKGROUND OF THE INVENTION

1. Field of the Invention

This invention relates to a bicycle or motorbike which has a hybrid propulsion system of muscle power and an electric motor supplied with current generated by a fuel cell. The fuel cell and battery and controls may be contained in module that fits in the triangular space formed by the frame of the bicycle between the front wheel of the bicycle and the seat.

2. Description of the Prior Art

U.S. Pat. No. 5,242,335 (Kutter) ('335), which is hereby incorporated by reference and is attached as an appendix to this application, discloses a bicycle driven by muscle power and an electric motor. This patent discloses a unique planetary-gear train on the drive wheel for utilizing both the power of an electric motor and muscle power.

U.S. Pat. No. 6,286,616 (Kutter) ('616), which is incorporated by reference and is attached hereto as an appendix, discloses a hybrid motorbike with an electric motor which has a rotor and a stator in the drive wheel for utilizing both muscle power and electric power.

### SUMMARY OF THE INVENTION

This invention provides a fuel cell for producing electricity to drive an electric motor powering a drive wheel of a two wheel vehicle, such as a motorbike or bicycle. The fuel cell and battery and controls for controlling the fuel cell and the electric motor can be placed in a module in the triangular opening formed by the frame of the bicycle between the front wheel and the rider's seat. This allows for easy replacement of the fuel cells and battery. Fuel cells will supply current to the electric motor that drives the drive wheel and to the battery for storing electricity for future supply to the electric motor.

The combination of the fuel cell and battery to supply current for the electric motor can be used with any hybrid motorbike that has a mechanism for utilizing both muscle power and power supplied by an electric motor. For example, this can be used with a planetary-gear train on the drive wheel as disclosed in the '335 patent. It can also be used where the electric motor is incorporated in the hub of the drive wheel supplied through the rotor and stator by the electric motor and muscle power as disclosed in the '616 patent.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a photograph of a motorbike of this invention being displayed by a gentleman.

FIG. 2 is a photograph of a part of the rear wheel and the fuel tank module for the fuel cell.

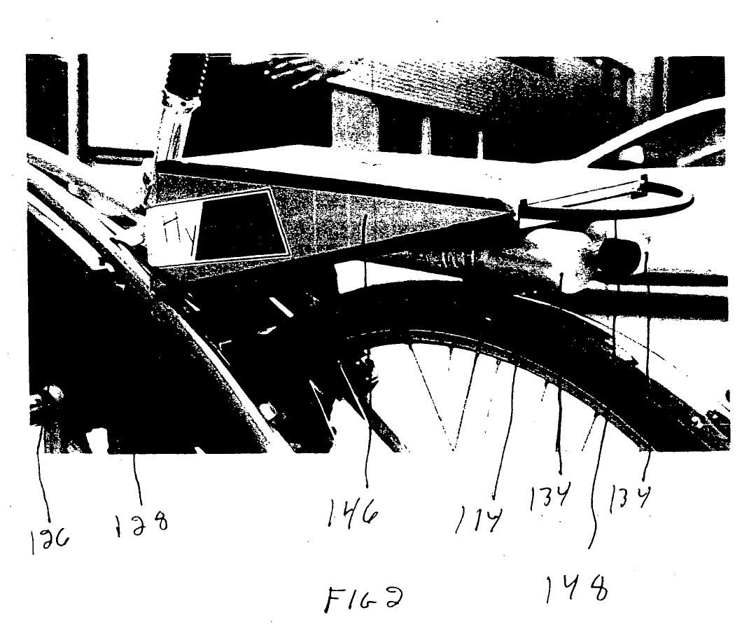

FIG. 3 is a photograph of the motorbike of this invention with the cover removed from the power module on one side.

FIG. 4 is a photograph of the electric motor used to partially power the motorbike of this invention.

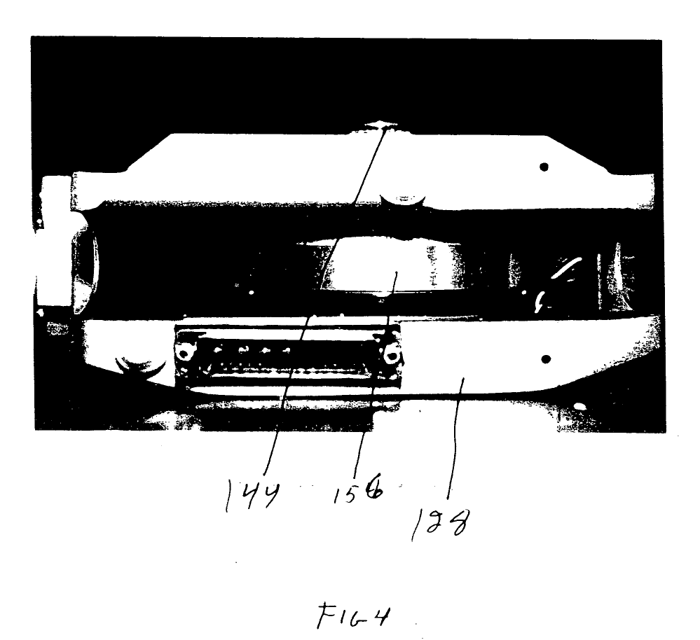

### DETAILED DESCRIPTION OF THE PREFERRED EMBODIMENT

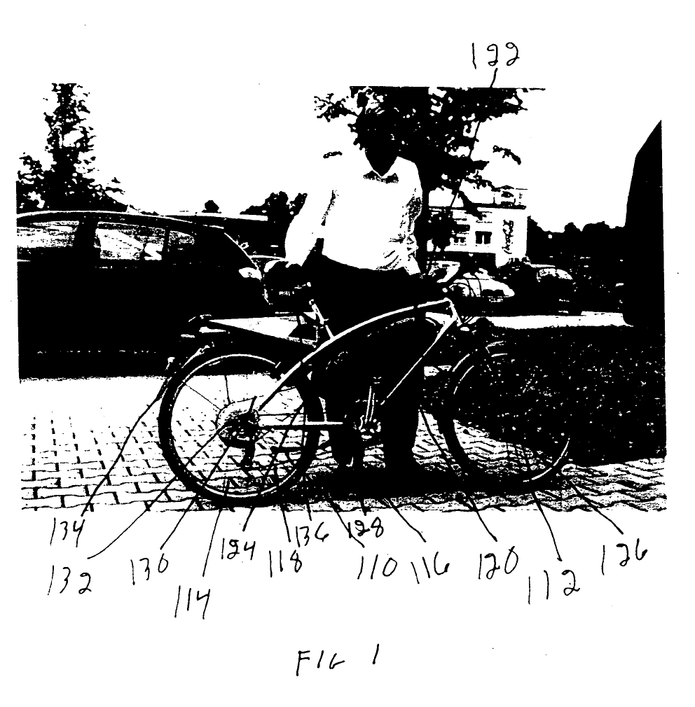

The embodiment shown in FIG. 1 shows a motorbike with a hybrid propulsion system. The hybrid motorbike 110 has a conventional frame and wheels with a front wheel 112, and a rear wheel 114 to which power is supplied. The motorbike has pedals 116 for supplying muscle power from the rider through a conventional gear on the pedal crank to which a pedal drive chain 118 is connected.

The frame of the bicycle has a bottom front fork 120 and a top front fork 122 which are supported and reinforced by a back connecting base 124. A power module 126 is supported in the triangular space formed by 120, 122, and 124. This power module 126 can be attached to the frame of the bicycle by any conventional means, such as bolts, which permit easy removal and installation. This bicycle has an electric motor 156 which is located immediately back of the back connecting base 124. A plastic motor drive belt 130 with teeth drives the rear wheel 114 of the motorbike. This motorbike has a seat 126 for the rider.

This motorbike 110 has a planetary-gear train 132. This planetary-gear train 132 is very similar to the planetary-gear train shown in FIG. 1 of the '335 patent. The crown gear (6) as shown in FIG. 1 of the '335 patent is driven by the pedal drive chain 118. The sun wheel (3) is driven by the motor drive belt 130. The planetary-gear train 132 allows both the supply of muscle power and power from the electric motor to be used in a complementary fashion.

This motorbike 110 is partially powered by one or more fuel cells 150 which operate on hydrogen. The hydrogen fuel tanks 134 are supported in a fuel tank module 146 attached to the rear of the bike. This fuel tank module 146 has a handle 148 for easy removal for exchange for a new module. This module 146 includes two hydrogen fuel tanks 134.

The hydrogen fuel tanks can store the hydrogen in the form of a hydrogen carbide, such as iron carbide, at relatively low pressure. These tanks 134 can be used to refuel from any convenient hydrogen source. It should be realized that high pressure hydrogen tanks may also be used.

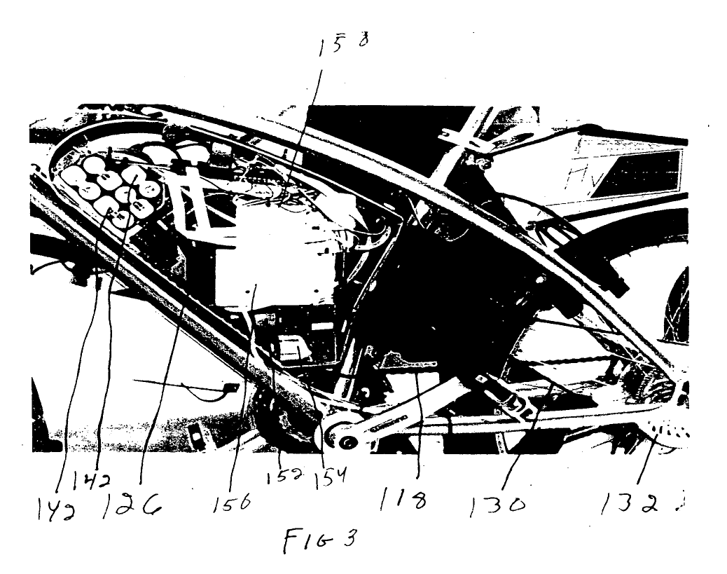

The power module 126 is shown in FIG. 3. It includes several batteries 142 and a stack of fuel cells 150 as shown in FIG. 3. There may be controls for starting and stopping the fuel cells 150. The power module 126 can also include controls for turning the electric motor on and off. The power module 126 can be attached to the back connecting base 124, top front fork 122 or the bottom front fork 120. When the battery or fuel cell expires or fails to operate, the entire module can be replaced. While the power module is the most convenient way to carry the fuel cells 150, it should be realized that the fuel cell or cells and the battery can be mounted on the bike without the use of a power module. The current produced by the fuel cells 150 is transmitted to the twenty-four volt electric motor 156 with any supplemental power used to charge the battery. A regulator, (not shown) can be used to control the distribution of current to the battery and to the electric motor 156 as desired. The electric motor 156 is encased in a case 128 which is attached to the frame of the bike. Controls can also be provided to automatically turn the fuel cells on and off in order to conserve fuel. This feature is not shown in the figures.

The fuel cells used in this invention use hydrogen from the hydrogen fuel tanks 134 and obtain oxygen from the air. The hydrogen can be pumped by pump 152 to the fuel cell. Air can be pumped to the fuel cells by air pump 154. The hydrogen and oxygen are combined in the fuel cell 142 to produce electricity with water vapor being the by-product. Since only water vapor is a by-product, no pollution of the atmosphere occurs in the use of this invention. While it is preferred that the fuel cell operate on hydrogen and oxygen, it should be realized that other types of fuel cells that produce electricity could be used as well. In the case of a fuel cell that uses hydrogen and oxygen, the oxygen is obtained from the atmosphere. Suitable wiring connects the electric controls the battery to the electric motor.

The electric motor 156 has a motor gear drive 144 to which the motor drive belt 130 is engaged. This electric motor can be a brushless d.c motor or other type of DC motor. This invention is not limited to a DC motor as other types of motors can be utilized by converting the current from the fuel cell to AC.

This motorbike is extremely efficient in that testing of the motorbike has confirmed that only 45 grams of hydrogen is needed to assist in powering the motorbike a distance of 125 kilometers.

The battery, or batteries, 142 can be a nickel cadmium battery or a long lasting lithium battery.

It should be pointed out that because of the small amount of hydrogen that is used, it is possible to use a small hydrogen generating unit in the home or garage to generate the hydrogen to fill the tanks. The hydrogen could be generated by electrolysis of water. Alternatively, it could be generated by a reformer of a mixture of methanol and water.

The battery used in this motorbike can be a 12 or 24 volt battery.

The turning of the motor on and off or to regulate its speed to assist in powering the bike can be controlled by software that determines the load on the pedals and their rpm to either supply power from the electric motor or not and how much power to supply. This microcomputer can be housed in the power module or with the electric motor to use this software. A manual control can override the software in determining when the motor is turned on or off.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

1. A two wheel motor vehicle powered at least in part by a fuel cell comprising:
a vehicle frame supporting at least one front wheel and one back wheel and a seat, said frame forming an opening between the wheels for the placement and attachment to the frame of a power module;
a front axle supporting any front wheel;
a rear axle supporting any rear wheel;
a power module, said module including a fuel cell, battery, and control means for controlling the power to a wheel of the vehicle;
a fuel tank;
means for detachably attaching the power module to the frame;
and an electric motor for powering a wheel of the vehicle.

2. The fuel cell powered vehicle of claim 1, in which the opening in the frame between the wheels is triangular in shape.

3. The fuel cell powered vehicle of claim 1, in which the vehicle has a hybrid power system consisting of an electric motor and a mechanical power source supplied by a person.

4. The fuel cell powered vehicle of claim 2, in which the vehicle has a hybrid power system consisting of an electric motor and a mechanical power source supplied by a person.

5. The fuel cell powered vehicle of claim 1, in which the fuel cell is designed to produce electricity from hydrogen and oxygen with oxygen obtained from the atmosphere and the hydrogen obtained from the fuel tank.

6. The fuel cell powered vehicle of claim 5, in which the hydrogen is stored in the fuel tank as a hydrogen carbide.

7. The fuel cell powered vehicle of claim 6, in which the carbide is an iron carbide.

8. The fuel cell powered vehicle of claim 3, in which the mechanical power is mechanically transmitted by a person to the wheel of the vehicle being driven by pedals attached to a gear which is interconnected to a gear on the wheel being driven by a chain.

9. A two wheel motor vehicle with hybrid propulsion system for driving a drive wheel comprising:
a vehicle frame supporting a front wheel and a back wheel and a seat;
a front axle supporting the front wheel;
a rear axle supporting the rear wheel;
a pedal crank;
said vehicle having a fuel tank, a fuel cell for generating electricity, a battery, and an electric motor for powering a drive wheel and controls for the fuel cell and electric motor;
said electric motor having a rotor and a stator forming a first propulsion source with a first rotation per minute(rpm) and a first torque, and a second propulsion source with a second rpm and a second torque, with the stator of the electric motor rotatably arranged on one of an axle and a shaft of a drive train between the pedal crank and the drive wheel which can be mechanically connected with the second propulsion source so that the stator is driven by the second propulsion source, and the rotor of the electric motor having a rotational speed that that corresponds to a sum of the first rpm of the first propulsion system and the second rpm of the second propulsion system.

10. The two wheel vehicle of claim 9, in which the fuel cell generates electricity from oxygen and hydrogen and the fuel tank is designed to contain hydrogen.

11. The two wheel vehicle of claim 9, in which there is a control to regulate the fuel cell and a control to regulate the speed of the electric motor.

12. The two wheel vehicle of claim 9, wherein the second propulsion source is a muscle powered propulsion system.

13. The two wheel vehicle of claim 9, in which the vehicle is a bicycle.

14. A two wheel motor vehicle with a hybrid propulsion system for driving a drive wheel comprising:
a vehicle frame supporting a front wheel and a back wheel and a seat;
a front axle supporting the front wheel;
a rear axle supporting the rear wheel;
a pedal crank for supplying muscle power;
said vehicle having a fuel tank, a fuel cell for generating electricity, a battery, and an electric motor for powering a drive wheel and controls for the fuel cell and electric motor; and
said drive wheel having a planetary-gear train having sun wheel (3) driven by an electric motor, a crown gear (6) driven by said muscle power, and a planetary-gear carrier (5) of the driven wheel 114 of the hybrid drive vehicle, said planetary-gear carrier (5) providing a power take-off to the drive wheel 114.

15. The two wheel vehicle of claim 14, in which the fuel cell generates electricity from oxygen and hydrogen and the fuel tank is designed to contain hydrogen.

16. The two wheel vehicle of claim 14, in which there is a control to regulate the fuel cell and a control to regulate the speed of the electric motor.

17. The two wheel vehicle of claim 14, in which the vehicle is a bicycle.

18. A two wheel motor vehicle of claim powered at least in part by a fuel cell comprising:
a vehicle frame supporting at least one front wheel and one back wheel and a seat, said frame forming an opening between the wheels for the placement and attachment to the frame of a power module;
a front axle supporting any front wheel;
a rear axle supporting any rear wheel;
a pedal crank powered by muscle power;
a power module, said module including a fuel cell, battery, and control means for controlling the power to a wheel of the vehicle;
a fuel tank;
means for detachably attaching the power module to the frame;
an electric motor for powering a drive wheel of the vehicle;
said drive wheel having a planetary-gear train having sun wheel (3) driven by an electric motor, a crown gear (6) driven by said muscle power, and a planetary-gear carrier (5) of the driven wheel 114 of the hybrid drive vehicle, said planetary-gear carrier (5) providing a power take-off to the drive wheel 114.

19. The two wheel vehicle of claim 9, in which the fuel cell generates electricity from oxygen and hydrogen and the fuel tank is designed to contain hydrogen.

20. The two wheel vehicle of claim 9, in which there is a control to regulate the fuel cell and a control to regulate the speed of the electric motor.

21. The two wheel vehicle of claim 18, in which said opening between the wheels is triangular in shape defined by a top front fork (122) a bottom front fork (120) and a back connecting base (124).

22. The two wheel motor vehicle of claim 18, in which the electric motor drives a sun wheel (3) by a chain, and the crown gear (6) is driven by a chain attached to a gear on the pedal crank which is driven by muscle power.

23. The two wheel motor vehicle of claim 22, in which the electric motor drives a sun wheel (3) by a chain, and the crown gear (6) is driven by a chain attached to a gear on the pedal crank which is driven by muscle power.

24. The fuel cell powered vehicle of claim 18, in which the fuel cell is designed to produce electricity from hydrogen and oxygen with the oxygen obtained from the atmosphere and the hydrogen obtained from the fuel tank.

25. The fuel cell powered vehicle of claim 18, in which the hydrogen is stored in the fuel tank as a hydrogen carbide.

26. The fuel cell powered vehicle of claim 25, in which the carbide is an iron carbide.

27. The fuel cell powered vehicle of claim 18, which has sensors to determine the speed of and load placed on the pedals and transmit this information to a microprocessor in the vehicle which has been programmed to control the speed of the electric motor according to the load on the pedals and their speed so as to provide the desired assistance in pedaling the vehicle.
